(19) United States
(12) Patent Application Publication
(10) Pub. No.: US 2009/0091729 A1
(43) Pub. Date: Apr. 9, 2009

(54) Lithography Systems and Methods of Manufacturing Using Thereof

(76) Inventors: Sajan Marokkey, Wappingers Falls, NY (US); Alois Gutmann, Poughkeepsie, NY (US); Chandrasekhar Sarma, Poughkeepsie, NY (US); Henning Haffner, Pawling, NY (US); Roderick Koehle, Ottobrunn (DE)

Correspondence Address: SLATER & MATSIL LLP, 17950 PRESTON ROAD, SUITE 1000, DALLAS, TX, 75252, US

(21) Appl. No.: 11/868,362

(22) Filed: Oct. 5, 2007

(51) Int. Cl. G03B 27/32; G03B 27/54

(52) U.S. Cl. 355/67; 355/77

(57) ABSTRACT

Lithography systems and methods of manufacturing semiconductor devices are disclosed. For example, a lithography system includes at least two reticle stages and a common projection lens system disposed between the reticle stages and a wafer stage, and at least one alignment system for aligning the reticle stages.

### TECHNICAL FIELD

The present invention relates generally to the fabrication of semiconductor devices, and more particularly to lithography systems used to pattern material layers of semiconductor devices.

### BACKGROUND

Generally, semiconductor devices are used in a variety of electronic applications, such as computers, cellular phones, personal computing devices, and many other applications. Home, industrial, and automotive devices that in the past comprised only mechanical components now have electronic parts that require semiconductor devices, for example.

Semiconductor devices are manufactured by depositing many different types of material layers over a semiconductor workpiece or wafer, and patterning the various material layers using lithography. The material layers typically comprise thin films of conductive, semiconductive, and insulating materials that are patterned and etched to form integrated circuits (ICs). There may be a plurality of transistors, memory devices, switches, conductive lines, diodes, capacitors, logic circuits, and other electronic components formed on a single die or chip, for example.

Optical photolithography involves projecting or transmitting light through a pattern comprising optically opaque areas and optically clear or transparent areas on a mask or reticle. For many years in the semiconductor industry, optical lithography techniques such as contact printing, proximity printing and projection printing have been used to pattern material layers of integrated circuits. Lens projection systems and transmission lithography masks are used for patterning, wherein light is passed through the lithography mask to impinge upon a photosensitive material layer disposed on a semiconductor wafer or workpiece. After development, the photosensitive material layer is then used as a mask to pattern an underlying material layer. The patterned material layers comprise electronic components of the semiconductor device.

There is a trend in the semiconductor industry towards scaling down the size of integrated circuits to meet the demands of increased performance and smaller device size. However, as features of semiconductor devices become smaller, it becomes more difficult to pattern the various material layers because of diffraction and other effects that occur during a lithography process. For example, key metrics such as resolution and depth of focus of the imaging systems may suffer when patterning features at small dimensions.

Lithographic enhancement techniques have been aggressively pursued and adopted to overcome these limitations. These techniques relate to improvements in the optical systems (exposure apparatus), types of masks (phase shift masks, trimming masks, etc.) or the resists. However, such enhancements to lithographic techniques have a number of limitations such as throughput and manufacturability.

What are needed in the art are lithography systems and methods of manufacture thereof that are cost-effective while still retaining the benefits of lithography enhancing techniques.

### SUMMARY OF THE INVENTION

These and other problems are generally solved or circumvented, and technical advantages are generally achieved, by preferred embodiments of the present invention which provide lithography masks and methods of manufacture thereof.

In accordance with a preferred embodiment of the present invention, a lithography system comprises at least one illuminator, at least two reticle stages, a common projection lens system disposed between the reticle stages and a wafer stage, and at least one alignment system optically connected to the at least two reticle stages.

The foregoing has outlined rather broadly the features and technical advantages of embodiments of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a lithography system in accordance with an embodiment of the current invention;

FIG. 2, which includes FIGS. 2a-2b, illustrates lithography systems in accordance with an embodiment of the invention;

FIG. 3 illustrates a lithography system in accordance with an embodiment of the invention;

FIG. 4, which includes FIGS. 4a-4b, shows lithography systems in accordance with an embodiment of the invention;

FIG. 5 illustrates methods of using the lithography systems, in various embodiments of the invention;

FIG. 6 illustrates an alternate method of using the lithography systems, in accordance with an embodiment of the invention;

FIG. 7, which includes FIGS. 7a-7c, illustrates a method of generating lithography masks for use with lithography systems, wherein each mask patterns features of different types, in accordance with an embodiment of the invention;

FIG. 8, which includes FIGS. 8a-8c, illustrates a method of generating lithography masks for use with lithography systems, wherein each mask patterns features having different orientations, in accordance with an embodiment of the invention;

FIG. 9, which includes FIGS. 9a-9c, illustrates a method of generating lithography masks for use with lithography systems, wherein the masks are separated based on feature density, in accordance with an embodiment of the current invention;

FIG. 10, which includes FIGS. 10a-10c, illustrates a method of generating lithography masks for use with lithography systems, wherein the masks are separated based on feature density and/or OPC requirements, in accordance with an embodiment of the invention;

FIG. 11, which includes FIGS. 11a-11c, illustrates a method of generating lithography masks for use with lithography systems, wherein the masks form images in a same region, in accordance with an embodiment of the invention;

FIG. 12, which includes FIGS. 12a-12d, illustrates a method of generating lithography masks for use with lithography systems, wherein the masks are separated as form and erase masks, in accordance with an embodiment of the invention;

FIG. 13, which includes FIGS. 13a-13e, illustrates a method of generating lithography masks for use with lithography systems, wherein the masks form images in a same region and separated as phase shift masks and erase masks, in accordance with an embodiment of the invention;

FIG. 14, which includes FIGS. 14a-14c, illustrates a method of generating lithography masks for use with lithography systems, wherein the masks when used together improve the effective resolution of the lithography system, in accordance with an embodiment of the invention;

FIG. 15, which includes FIGS. 15a-15b, illustrates a method of aligning the reticle stages and masks of a lithography system, in accordance with an embodiment of the invention;

FIG. 16 illustrates a test pattern on a wafer for testing the misalignment between the masks or reticle stages, in accordance with an embodiment of the invention; and

FIG. 17, which includes FIGS. 17a-17b, illustrates in FIG. 17a a cross-sectional view of a semiconductor device that has a layer of photo resist disposed thereon and that has been patterned using embodiments of the invention, and illustrates in FIG. 17b the semiconductor device of FIG. 17a after the layer of photoresist has been used as a mask to pattern a material layer of the semiconductor device.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Embodiments of the present invention achieve technical advantages by providing a lithography system and methods of manufacture thereof wherein an independent optical path is provided along with independent reticle stages for holding one or more masks in position. The masks are imaged simultaneously or sequentially to improve lithography process windows, throughput and/or imaging.

The resolution R of an optical lithography system is generally related to a ratio of the optical wavelength λ of the radiation used for exposure to the numerical aperture NA of the optical system used to direct radiation from an irradiated mask to the wafer (e.g., R=k₁λ/NA). Thus, increases in basic resolution require decreases in wavelength or increases in optical system numerical aperture. However shorter illumination wavelengths cannot use many convenient optical materials, as suitable refractive optical materials are unavailable. Increases in optical system numerical aperture are more difficult to achieve, and increased numerical aperture can reduce the tolerance of lithographic processes to defocus. Further, the k₁ factor depends on the imaging system, but has a theoretical limit of 0.25. Current lithography systems already operate around 0.3 and further reduction in this factor is difficult.

One way of overcoming this barrier is to use a double exposure process. In the double exposure process, a first exposure step is followed by a second exposure step, and the final image is a superposition of the two steps. For example, features at a 70 nm pitch may be printed as two interleaved 140 nm pitches, and the effective k₁ achieved would be about half the actual k₁ of the imaging system. However, there are at least two primary challenges in the adoption of double exposure techniques. First, the use of two masks sequentially requires movement of the reticle stage and mask after the first exposure and positioning of a second reticle stage and mask. Consequently, this process is vulnerable to mask misalignment errors. Any error in alignment between the masks results in erroneous superposition of the two exposures. Further, the second challenge in the adoption of this double exposure process relates to throughput, due to the use of two separate exposure steps.

In an embodiment of the invention, the lithography system is modified to include at least two independent optical paths and corresponding masks for each optical path. The masks are not removed between the first and second exposure steps. Hence, embodiments of the invention include simultaneous synchronization of both mask stage movements to each other and with respect to the wafer stage movement to reduce mask alignment errors.

The present invention will be described with respect to embodiments in a specific context, namely the lithography system for a double exposure process applied to semiconductor device manufacturing. The invention may also be applied, however, to the printing of other small devices and structures. For example, the invention may be applied to pattern other types of devices in other applications and other technological fields.

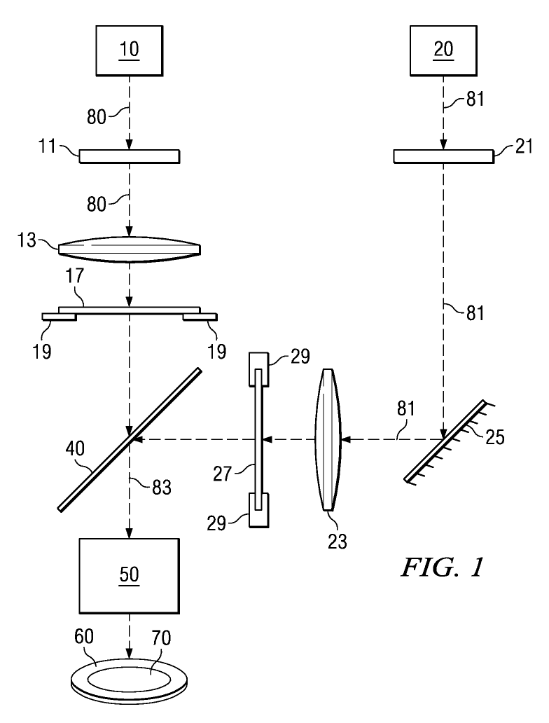

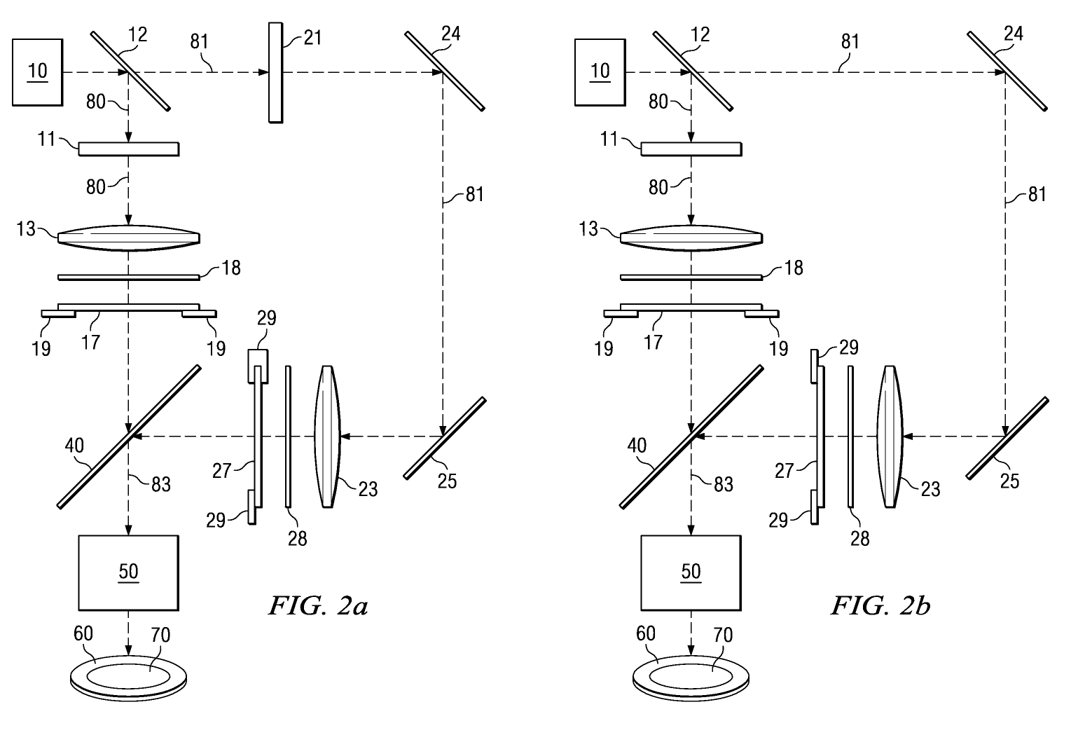

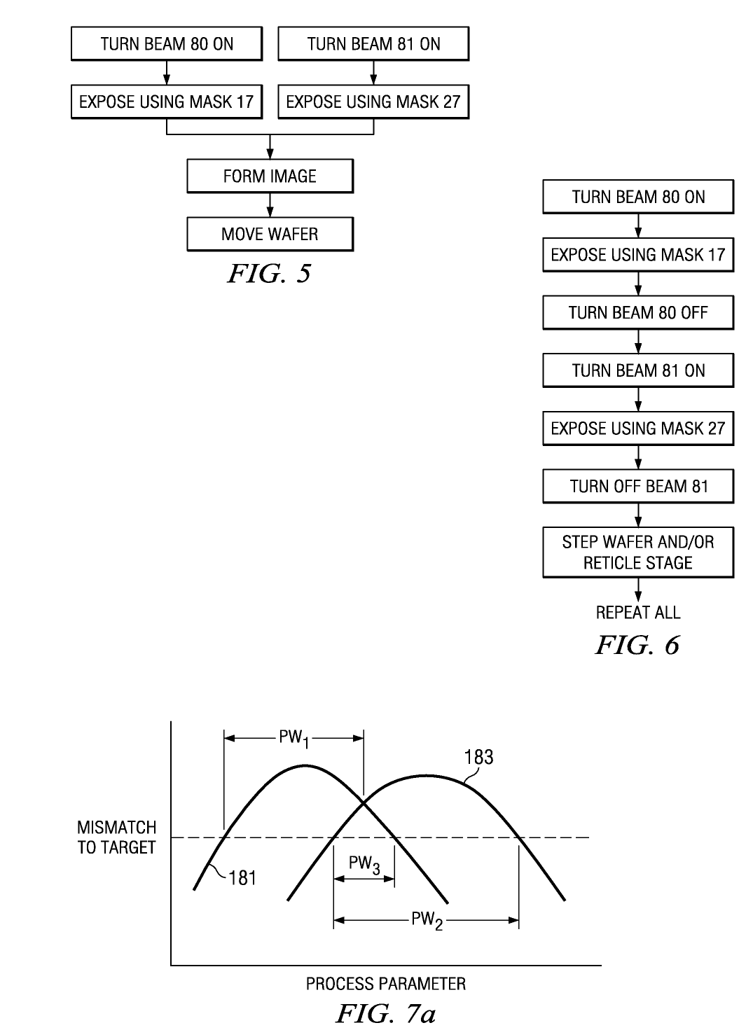

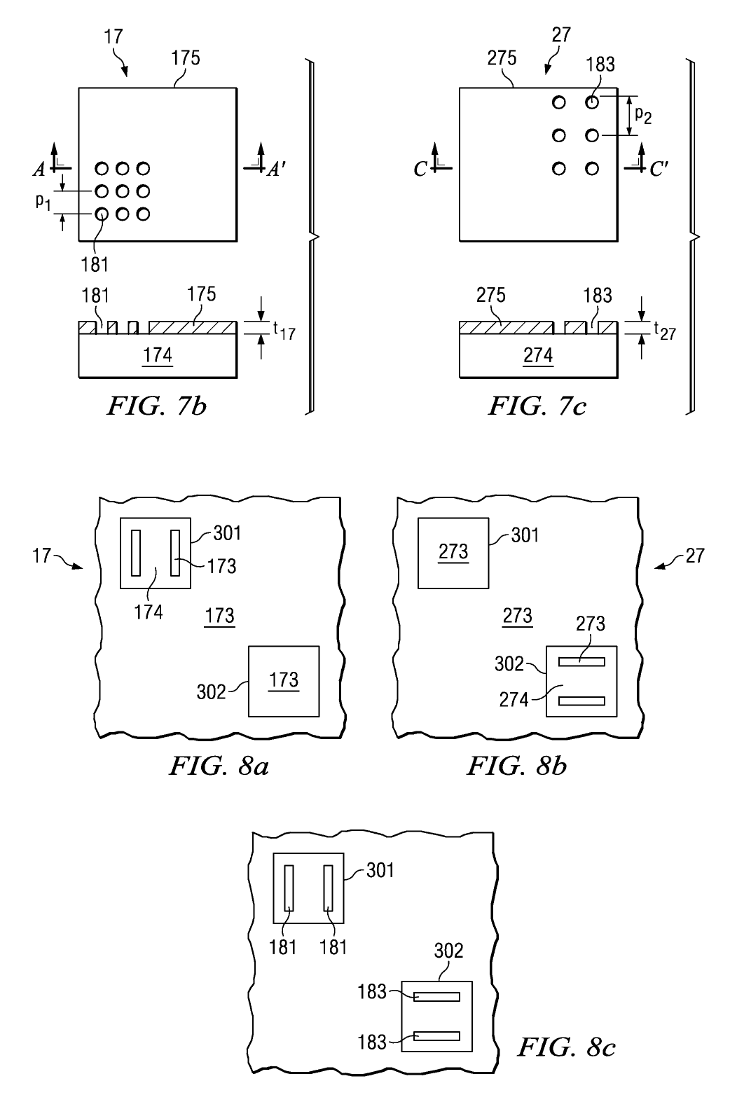

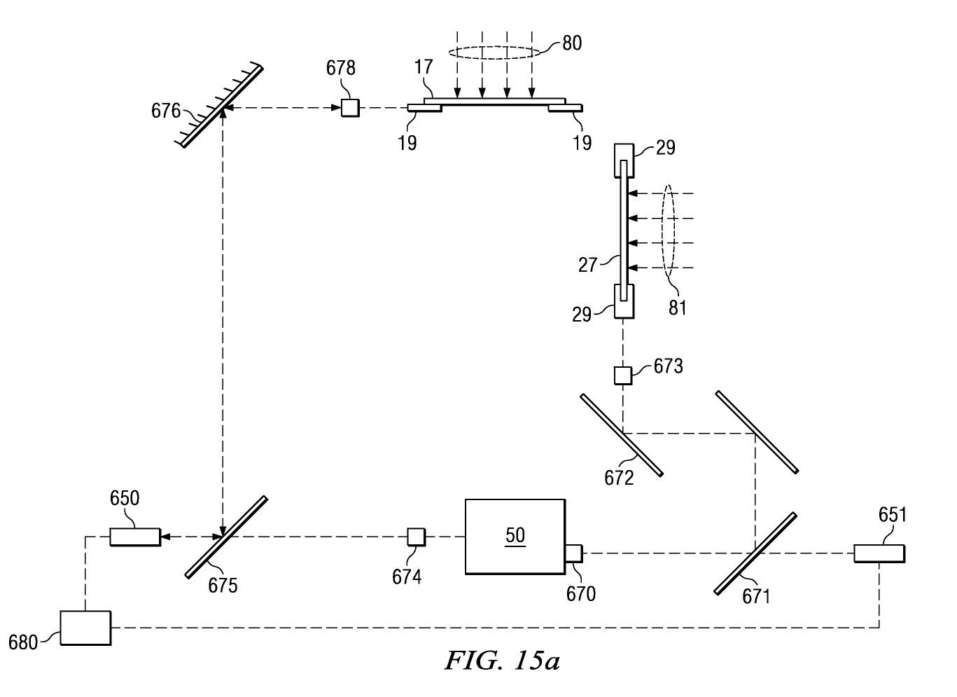

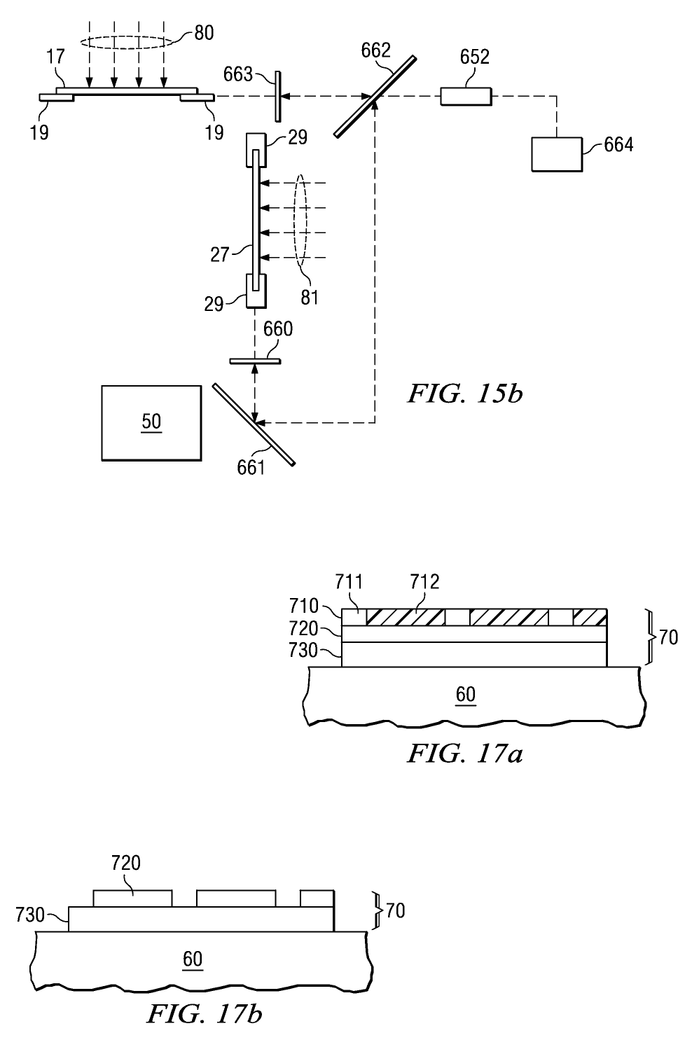

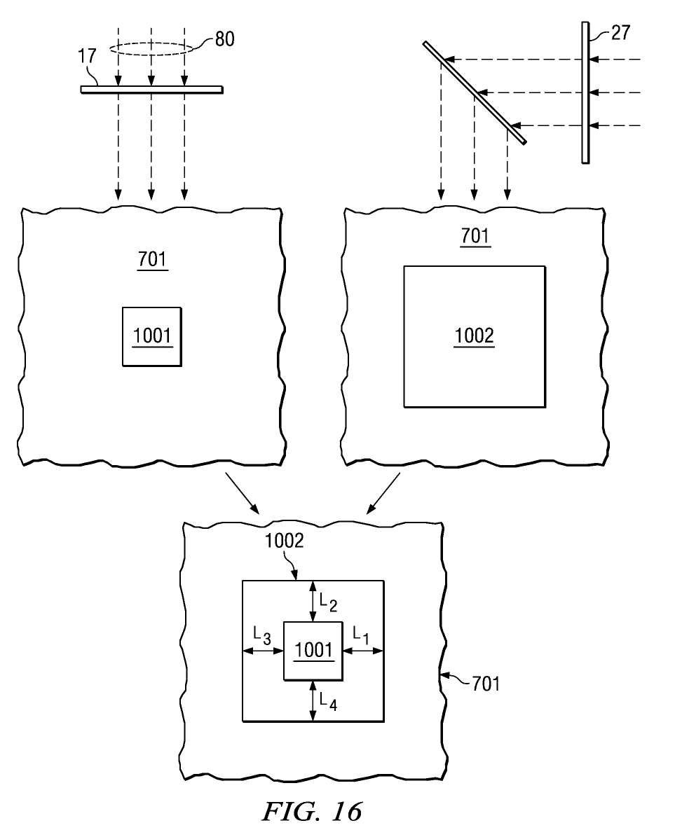

A lithography system in accordance with an embodiment of the invention is shown in FIG. 1, and various embodiments of the lithography system are described in FIGS. 2-4. Various methods using embodiments of the invention are described in FIGS. 5-6. Various methods of generating lithography masks in various embodiments of the invention are described in FIGS. 7-13. Embodiments of the invention for calibrating the lithography systems to minimize mask alignment errors are described using FIGS. 14 and 15. Further, FIG. 16 describes the use of embodiments of the invention to form semiconductor devices.

Referring to FIG. 1, the lithography system comprises a first illuminator 10 and a second illuminator 20. The illuminators 10 and 20 provide light with suitable optical characteristics such as wavelength, intensity, etc. For example, the illuminators 10 and 20 may emit a single wavelength of light such as from a laser source. A specific example of such a laser source is ArF, an excimer laser, that produces light with a wavelength of 193 nm. In various embodiments, the illuminators 10 and 20 emit near ultraviolet (UV) or preferably deep ultraviolet (UV) light; e.g., light with wavelengths of 248 nm, 193 nm or 157 nm, although light having other wavelengths may also be used. In different embodiments, other lasers and wavelengths are possible. The illuminators 10 and 20 may be individually controlled to optimize the characteristics of the exiting light radiation. For example, the light intensity, pulse width, polarization or time of exposure may be separately modulated by the illuminators 10 and 20.

The first illuminator 10 radiates a first optical beam 80 and the second illuminator 20 radiates a second optical beam 81. The un-polarized optical beams 80 and 81 pass through polarizers 11 and 21 that may convert the un-polarized light to polarized light, if required for a particular application.

A light of a single wavelength consists of an electromagnetic field in which electric fields and magnetic fields oscillate at a defined frequency. However, the electric field is unrestricted in that it exists in a plurality of directions relative to the direction of propagation of light. After passing through the polarizers 11 and 21, only particular electric field and magnetic field oscillations remain. In some embodiments, only oscillations parallel to the layout feature remain.

In some embodiments, the optical beams 80 and 81 are orthogonally polarized, although in other embodiments they may be non-orthogonal. Further, in preferred embodiments, only the transverse electric (TE) and transverse magnetic (TM) modes are used. In the TE mode, the light beam comprises only the transverse electric field, and both the transverse and longitudinal components of the magnetic field. In the TM mode, the light beam comprises only the transverse magnetic field, and both the transverse and longitudinal components of the electric field.

In other embodiments, only linearly polarized light beams may be used wherein the electric field and magnetic field are oriented along only one single direction. For example, the polarized light may comprise a vertically polarized (“V”) light in which the electric field is restricted to lie along the z-axis for a light propagating along the x-axis, and similarly a horizontally polarized (“H”) light in which the electric field lies along the y-axis.

The lithography system is setup such that the first optical beam 80 passes through a first mask 17 positioned on a mask stage or first reticle stage 19 and enters the beam splitter 40. The second optical beam 81 similarly enters the second mask 27 positioned on a mask stage or reticle stage 29 and enters the beam splitter 40. The beam splitter 40 is, preferably, a non-polarizing beam splitter. The beam splitter 40 combines the first optical beam 80 and the second optical beam 81 and creates a composite optical beam 83. In some embodiments, the first mask 17 and second mask 27 may be aligned parallel. The optical paths 80 and 81 may include additional mirrors before being merged by the beam splitter 40.

The composite optical beam 83 having passed through the two separate masks 17 and 27 contains optical information to form a final composite image on a semiconductor device or workpiece 70.

Suitable modifications to the optical path of the first optical beam 80 and the second optical beam 81 may be introduced to improve the final composite image by changing either the first optical beam 80 or the second optical beam 81 or in some cases both beams. For example, in some embodiments, the optical path of the first optical beam 80 and/or the second optical beam 81 is altered to produce a phase difference between the two beams in multiples of about 2π to enable constructive interference. However, in some embodiments, the first optical beam 80 and/or the second optical beam 81 may be altered to produce a phase difference between the two beams in multiples of about (2n−1)π to enable destructive interference.

A mirror 25 may be introduced to redirect the second optical beam 81 as shown in FIG. 1. Further, the first optical beam 80 and the second optical beam 81 may pass through conventional auxiliary elements such as a condenser lens system. For example, the optical path of the optical beams 80 and 81 may include diffractive optical elements (DOEs) 13 and 23, for example, to shape the beam to be circular or annular. In some embodiments, the first optical beam 80 and the second optical beam 81 may be suitably modified to be partially coherent, although other embodiments may use completely coherent or incoherent illumination.

The first and second masks 17 and 27 may comprise any type of masks. For example, in various embodiments, the first mask 17 may be a binary mask, an attenuated phase shift mask, an alternating phase shift mask, etc. Similarly, the second mask 27 may be a binary mask, an attenuated phase shift mask, an alternating mask, etc. The lithography system in other embodiments may be adapted for enhancing the imaging system further.

The lithography system further includes a support or stage 60 for a semiconductor device or workpiece 70 and a common projection lens system 50 disposed proximate the semiconductor device 70 and support 60, as shown. The projection lens system 50 may include a plurality of lenses (not shown), and may include a fluid disposed between the semiconductor device 70 mounted on the support 60 and a last lens of the projection lens system 50, e.g., in an immersion lithography system. The lithography system may comprise a stepper or a step-and-scan apparatus (not shown), wherein the stage 60 is adapted to move the semiconductor device 70 while the masks 17 and 27 are held stationary during the exposure process when using a stepper or are moved synchronized to the wafer stage movement when employing a step-and-scan system. In various embodiments, the lithography system may comprise a scanner-stepper, wherein the stage 60 and reticle stages 19 and 29 are adapted to move during the exposure process, for example. The lithography system may also be adapted for immersion lithography applications, for example.

The lithography system also comprises a feedback mechanism or self-monitor to test the optical integrity of the exposure tool. The optical test may include optical characteristics such as path difference, intensity difference between the various optical paths, and misalignment between various components of the tool including the masks. For example, before processing semiconductor wafers, the lithography system may perform an automated self-check. Based on the feedback from this self-check, the various components can be adjusted, for example, to minimize the phase difference between optical beams. For example, the lithography system may comprise an additional phase detector to enable accurate phase matching of the beams 80 and 81. In one such embodiment, the optical beam 81 passes directly through the beam splitter 40, whereas the optical beam 80 is reflected by the beam splitter 40. A phase detector located opposite the mask 27 collects the optical beam passing through, for example, a transparent area of the masks. The incident phase of the optical beams 80 and 81 may be fine-tuned based on the feedback from such a phase detector.

As will be clear from other embodiments discussed below, the lithography tool can be employed in a variety of different configurations and applications. Further, other lithographic methods aimed at improving resolution may be combined with embodiments of the invention. Examples include modification to light sources (e.g., Off-Axis Illumination), use of special masks for either or both masks, which exploit light interference phenomena (e.g., Attenuated Phase Shift Masks, Alternating Phase Shift Masks, Chromeless Masks, etc.), and mask layout modifications (e.g., Optical Proximity Corrections).

Additional embodiments of the invention of the lithography system will now be described using FIGS. 2a-2b, FIG. 3, and FIGS. 4a-4b.

Embodiments of the lithography system will now be discussed using FIG. 2, which includes FIG. 2a and FIG. 2b. Referring first to FIG. 2a, the lithography system comprises an illuminator 10. The optical beam generated by the illuminator 10 is split by a non-polarizing beam splitter 12. The beam splitter 12 generates two optical beams 80 and 81. The optical beam 80 passes through a polarizer 11, whereas the optical beam 81 passes through a polarizer 21. The optical beam 81 is further reflected by mirrors 24 and 25 and directed back as shown in FIG. 2a. The optical paths for the optical beams 80 and 81 may be specifically controlled to enable constructive or destructive interference. Further, other needed elements such as diffractive optical elements (DOEs) may be included. The lithography system may hence comprise DOEs 13 and 23. Similarly, other components may be suitably added to improve image formation. For example, the optical paths of optical beams 80 and 81 contain absorption filters 18 and 28. The absorption filters 18 and 28 may be independently controlled and may modulate the intensity of light transmitted in each of the optical paths. Similarly, various embodiments could include phase scramblers (not shown), for example, to reduce the coherence between the optical beams 80 and 81. The phase scramblers scramble the phase of the incident optical beam and render the optical beams 80 and 81 partially coherent or incoherent. Partially coherent light is advantageously used over coherent light in various embodiments to enable printing of finer features. The use of incoherent light reduces the interference related effects between the two optical paths and hence reduces the requirements imposed on the lithography system, and thus enables a cost effective means of manufacturing using the lithography system.

Another embodiment of the lithography system is shown in FIG. 2b. Again, the lithography system comprises a single illuminator 10 combined with a beam splitter 12. Here, the beam splitter 12 splits the non-polarized beams into two different beams with different polarization. The first optical beam 80 and the second optical beam 81 have different polarizations. However, in some embodiments, the first optical beam 80 and the second optical beam 81 may comprise the same polarization.

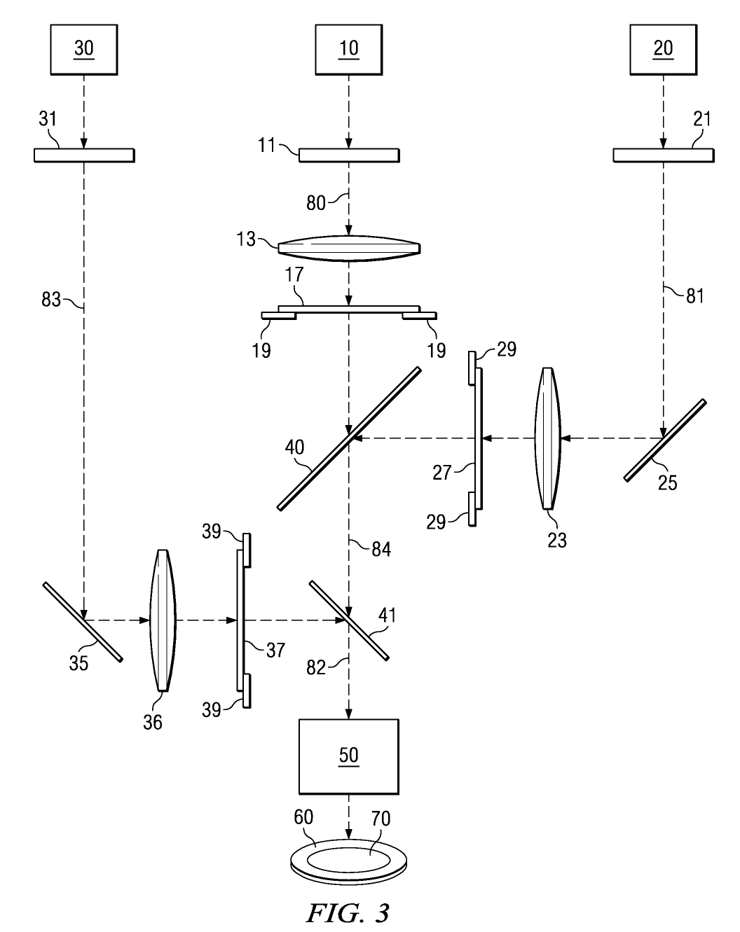

Another embodiment of the lithography system will now be described using FIG. 3. In this embodiment, three illuminators are present. The embodiment shown in FIG. 3 includes all the elements of the embodiments illustrated in FIG. 1 and further includes a separate third optical path and associated optics. For example, the illuminator 30 generates the optical beam 83 that passes through a third mask 37 mounted on a reticle stage 39. The associated third path as shown includes a mirror 35 and a diffractive element 36. The first and second optical beams 80 and 81, after passing through the masks 17 and 27, combine to form a single beam 84. The optical beam 83 combines with the optical beam 84 into optical beam 82 using a beam splitter 41. In some embodiments, the first and second optical beams are more prone to energy loss. However, the relative energy of the third illuminator 30 can be suitably modified or normalized relative to the other two illuminators 10 and 20. Similarly, the illustration in FIG. 3 shows the plane comprising the third and first optical paths to be in the same plane as the plane comprising the first and second optical paths. However in different embodiments, the third optical path may be perpendicular to the second optical path or have other suitable orientations to the first or second optical path.

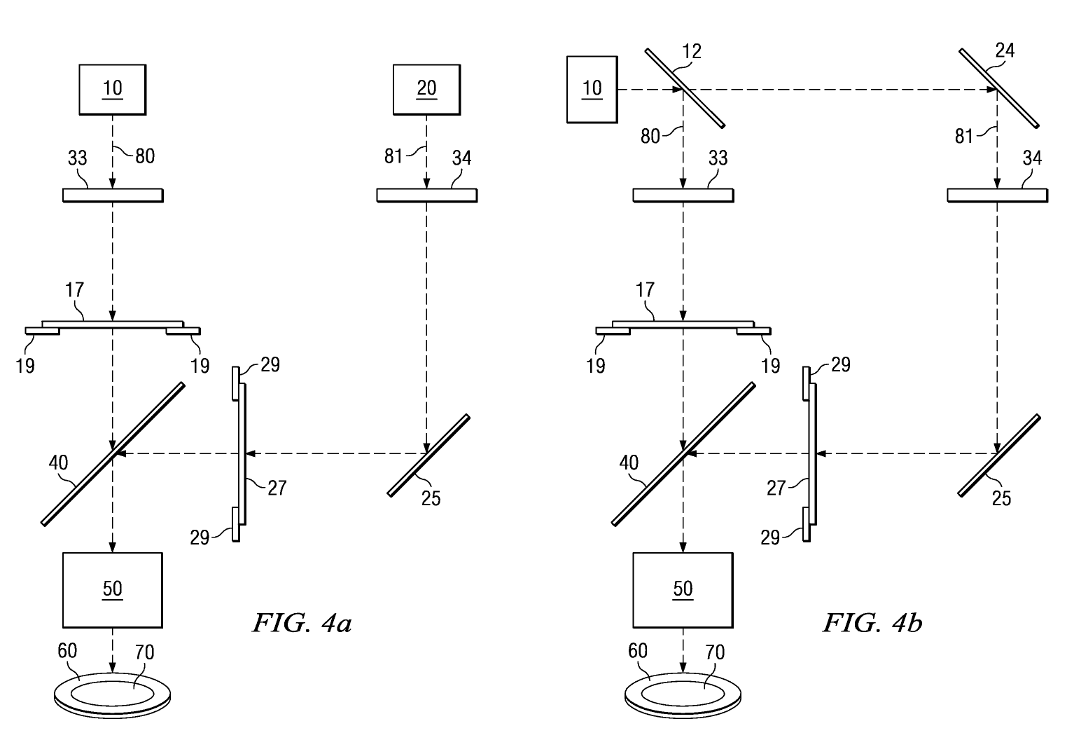

One embodiment of the lithography system will now be discussed using FIG. 4, which includes FIG. 4a and FIG. 4b. In this embodiment, the lithography system comprises optical switches 33 and 34 disposed between the illuminators 10 and 20 and masks 17 and 27. The optical switches 33 and 34 may be selectively shut off or turned off to block out a particular optical beam. For example, this may be done in some embodiments to minimize interference between the two optical beams. FIG. 4a illustrates an embodiment comprising a dual illuminator system, whereas FIG. 4b illustrates an embodiment for a single illuminator system. The typical elements of the lithography system have been left out to show the embodiment clearly.

Methods of using embodiments of the lithography systems in accordance with embodiments of the invention for semiconductor manufacturing will now be described using the flow chart of FIG. 5 and FIG. 6.

Referring to the embodiment illustrated in FIG. 5, the two optical paths are activated to turn on the optical beams 80 and 81 as shown, for example, in FIG. 1. The semiconductor body is exposed via the masks 17 and 27 to form an image. The wafer stage or support (e.g., support 60 of FIG. 1) moves the wafer and masks 17 and 27, so as to expose another region of the wafer. This process is performed until the desired regions of the wafer are exposed. In one embodiment, the wafer and masks 17 and 27 may be moved continually during exposure. In some embodiments, the wafer and masks 17 and 27 are moved and exposed sequentially.

Another embodiment of using the lithography system for semiconductor manufacturing will now be described using the flow chart of FIG. 6. The embodiment uses a double exposure, in which a first exposure is followed by a second exposure. This may be done, for example, for various applications whereby interference between the beams is not desired and may aim at improved image contrast or process window, etc.

The flow chart of FIG. 6 describes the embodiment using the double exposure process. The first mask 17 (e.g., of FIG. 1, 2, or 4) and second mask 27 (e.g., of FIG. 1, 2, or 4) are first aligned by a suitable technique. The optical switches 33 and 34 (described in FIG. 4) are powered such that the first beam 80 (e.g., in FIG. 4) is turned “on” and the second beam 81 (e.g., in FIG. 4) is blocked. The wafer is exposed using the first mask 17. Subsequently, the optical switch 33 is turned “off” and the optical switch 34 is turned “on.” In this condition, the second beam 81 is turned “on,” whereas the first beam 80 is turned “off.” After turning “off” both the optical beams 80 and 81, the wafer holder may be moved to focus the image on a different location or spot on the wafer. Thus, the above process is repeated across the wafer until the wafer is scanned completely.

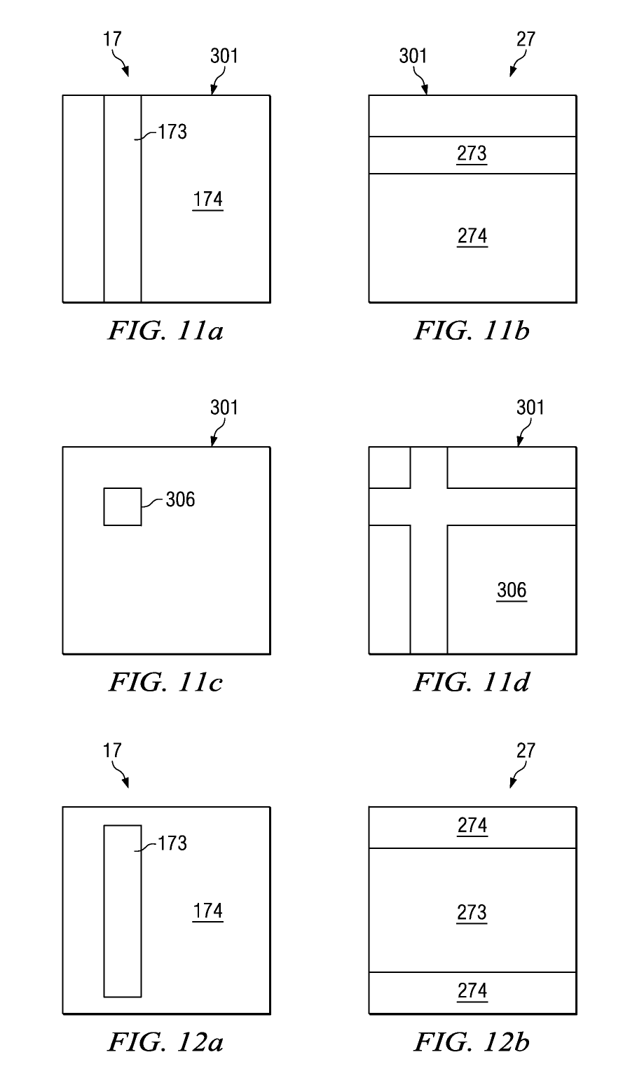

The lithography system and method of using the same, described in various embodiments so far, can use different types of masks based on application. Examples of some of these applications will be described using the embodiments shown in FIGS. 7-13. In particular, several schemes can be used in separating a given design or layout into two or multiple masks. For example, the first and second masks can either expose different regions of a semiconductor substrate or expose the same region of the semiconductor substrate. A first set of embodiments will be described using FIGS. 7-10, wherein the multiple masks expose different regions of the semiconductor substrate. Embodiments will also be described using FIGS. 11-13, wherein the multiple masks expose the same region of the semiconductor substrate. The embodiments illustrated in FIGS. 7-13 do not require coherency between the light beams passing through the first mask and the second mask. Although, in some embodiments, these light beams may also be coherent.

In some embodiments of the invention, multiple masks expose different regions of the semiconductor substrate. Hence, these methods may be adopted, for example, to alleviate the process window of current lithography techniques. FIGS. 8-10 illustrate the application of these embodiments to specific cases.

A typical OPC process has to be optimized for a variety of different features that comprise different openings and spaces. The complexity of printing such geometries due to, for example, proximity effects reduces the depth of focus of the exposure process and hence reduces the available process margin. It is well known that lithography process window and resolution are dependent on mask pattern. For example, particular features have a process window in which they are best exposed.

The invention in various embodiments overcomes these limitations by separating design portions with different process windows onto separate masks and the separated masks are exposed at different process conditions. This is illustrated in FIG. 7. FIG. 7a illustrates a plot of process parameter versus mismatch to target. For example, mismatch to target could be CD mismatch, a normalized measure of error between a target dimension and a printed dimension. To keep this mismatch to target within acceptable limits, a process window is needed. FIG. 7a shows the process window PW₁ for a first feature 181. Similarly, a second feature 183 has a different optimum operating condition, and thus has a different process window PW₂. If both these features have to be printed simultaneously, the allowed process window shrinks to PW₃ which may be too limited for realistic manufacturing. Such, features can be separated into different masks and exposed at their optimum condition, if a dual or multiple mask scheme as discussed in various embodiments of the invention is followed. This is illustrated in FIGS. 7b and 7c. For example, FIG. 7b displays the first mask 17 (e.g., of FIG. 1) comprising the first features 181 and FIG. 7c displays the second mask 27 (e.g., of FIG. 1) comprising the second features 183. The first and second features 181 and 183 could be formed at different dimensions, for example, different pitches p₁ and p₂. The regions 175 and 275 could be formed from films of varying thickness comprising different optical properties. For example, the films could modulate the optical paths of incident light in different ways. Examples of optical properties that may be modulated by the films include polarization, phase difference, and transmission. The exposure conditions of the first mask 17 and second mask 27 can be individually selected to maximize their respective process window, ensuring printing of both features successfully. Exposure optimization may include exposure dose, intensity, polarization, and direction of illumination. The mask may be co-optimized using an algorithm to automatically produce the two mask optimized for the best illumination and process window.

FIG. 8 illustrates an embodiment of the approach illustrated in FIG. 7. Referring first to FIG. 8, which includes FIGS. 8a-8c, FIGS. 8a and 8b describe the first mask 17 and second mask 27 and FIG. 8c illustrates the composite image formed by the superposition of the two separate optical beams 80 and 81 (e.g., of FIG. 1). As illustrated, in various embodiments, the masks regions may be different in different parts of the wafer. The first mask 17 in the illustrated regions of FIG. 8a comprises transparent regions 174 and opaque regions 173. The first mask 17 as shown in FIG. 8a comprises a first region 301 and a second region 302 (in FIG. 8c). The first mask 17 further comprises a plurality of first features 181 (see FIG. 8c) on the first region 301 but no features on the region 302. The first features 181 in various embodiments may include resolution enhancement features such as hammerheads, serifs, sub-resolution scatter bars, printed assist features, etc. Similarly, the substrate may comprise transparent regions 174 such as quartz or any other suitable modifications such as an alternating phase shift material.

The second mask in the illustrated regions of FIG. 8b comprises transparent regions 274 and opaque regions 273. Similarly, as shown in FIG. 8b, the second mask 27 comprises the first region 301 comprising no features and the second region 302 comprising a plurality of second features 183 (see FIG. 8c). The superposition of the optical beams 80 and 81 (e.g., of FIG. 1) creates a final composite image shown in FIG. 8c. The final image thus contains features from both masks 17 and 27. The first region 301 of the image comprises the plurality of first features 181 from the first mask 17, whereas the second region 302 of the image comprises the plurality of second features 183 from the second mask 27. For clarity, the final image or wafer size is shown enlarged relative to the masks.

In the embodiment shown in FIG. 8, the first features 181 on the first mask 17 are vertical whereas the second features 183 on the second mask 27 are horizontal. By separating the features into different masks, the illuminator condition is optimized for each mask and hence for each feature type individually. For example, the first mask 17 comprising vertical first features 181 may be exposed using a vertically polarized optical beam, whereas the horizontal second features 183 may be exposed using a horizontally polarized optical beam.

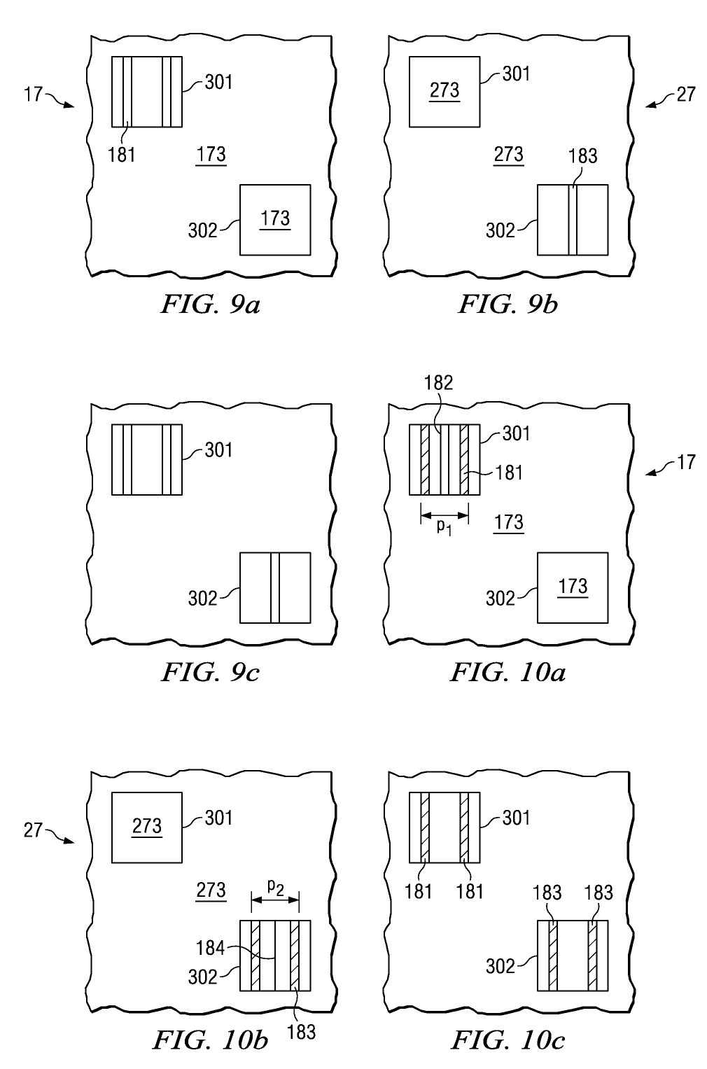

FIG. 9 illustrates an embodiment where the tightly packed lines 181 are formed in region 301 of the first mask 17 (shown in FIG. 9a), whereas the region 302 of the first mask 17 does not contain any features and is covered with opaque regions 173. Similarly, the region 301 of the second mask 27 is feature-less (covered with opaque regions 273), and isolated lines 183 are formed in region 302 of the second mask 27 (shown in FIG. 9b). Consequently, both these exposures can be independently optimized to form the composite image shown in FIG. 9c, comprising both the isolated and dense or tightly packed lines. Similarly, different pitch features can be separated into the two different masks in various embodiments. The use of positive resists as shown in the current embodiment is preferably used in patterning trenches, contact holes, etc. In some embodiments, negative resists may be preferably used for printing lines. For example, the first mask 17 may be covered with opaque regions 173. The lines to be printed in region 301 are formed by transparent regions on the first mask 17. Similarly, the second mask 27 may be covered with opaque regions 273. The lines to be printed in region 302 are formed by transparent regions on the first mask 27. Use of a negative resist process advantageously prohibits shadowing (exposure of resist under chrome due to diffraction effects) during exposure.

An embodiment of the invention is illustrated in FIG. 10. As shown in FIG. 10a, the region 301 of the first mask 17 comprises a plurality of first features 181 and a plurality of secondary features 182. For example, the first features 181 are the actual features to be printed. The secondary features 182 are added, for example, to improve the printing of the first features 181. Examples of the secondary features 182 include scatter bars, serifs, hammerheads, etc. The first mask 17 is optimized to print the first features 181. The first features 181 are separated by a first pitch p₁. Further, the region 302 of the first mask 17 does not have any features and is covered by opaque features 173. In the specific embodiment shown in FIG. 10a, the secondary features 182 comprise sub-resolution assist features or SRAFs. SRAFs are typically used to improve the apparent pattern density for larger pitch structures. Again in various embodiments, negative resists are advantageously used for printing lines and positive resists are advantageously used for printing trenches and contact holes.

Similar to the first mask 17, a different region 302 of the second mask 27, as shown in FIG. 10b, comprises a plurality of third features 183 separated by a second pitch p₂ and a plurality of fourth features 184, wherein the third features 183 are the actual features to be printed. The second mask 27 is again optimized to print the third features 183 and may include various OPC enhancements. Further, the region 301 of the second mask 27 does not have any features and is covered by opaque regions 273.

The composite image as shown in FIG. 10c illustrates the features 181 and 183. The composite image is formed by the superposition of the two masks 17 and 27. As each mask was optimized for the given feature, both features were printed clearly.

As described previously, in different embodiments of the invention, multiple masks expose the same regions of the semiconductor substrate. Hence, this method results in an exposure of a given region by two or multiple independent masks. FIGS. 11-14 illustrate the application of this embodiment to specific cases.

An embodiment of the invention is described in FIG. 11, which includes FIGS. 11a-11d, wherein FIGS. 11a and 11b describe the masks 17 and 27 and FIG. 11c illustrates the composite image formed by the superposition of the two separate optical beams 80 and 81 of e.g., FIG. 1. The embodiment described in FIG. 11 illustrates an example, wherein there is no phase difference between the optical paths passing through the masks 17 and 27. Further, the illustrated masks 17 and 27 are binary masks and include no phase change regions. These limitations are illustrated only for illustration of the concepts, and in various embodiments, the masks do not impose these limitations.

FIG. 11a illustrates the first mask 17 comprising a first region 301. The first region 301 comprises opaque regions 173 embedded in the transparent region 174. Similarly, the second mask 27 comprises the first region 301, which further comprises opaque regions 273 embedded in the transparent region 274.

The superposition of the optical beams 80 and 81 creates a final composite image. The actual printed pattern varies depending on the type of resist and type of mask. For example, if a positive resist is used as shown in FIG. 11c, islands 306 are formed, as the regions surrounding the islands 306 are exposed either by the first mask 17 or the second mask 27. Similarly, if a negative resist is used as shown in FIG. 11d, a contact hole may be formed in the region 306 (which is removed). For example, isolation trenches or vias can be etched by this process. In various embodiments, this process may be combined with other advances in lithography techniques such as advances in resist materials and/or resist stacks.

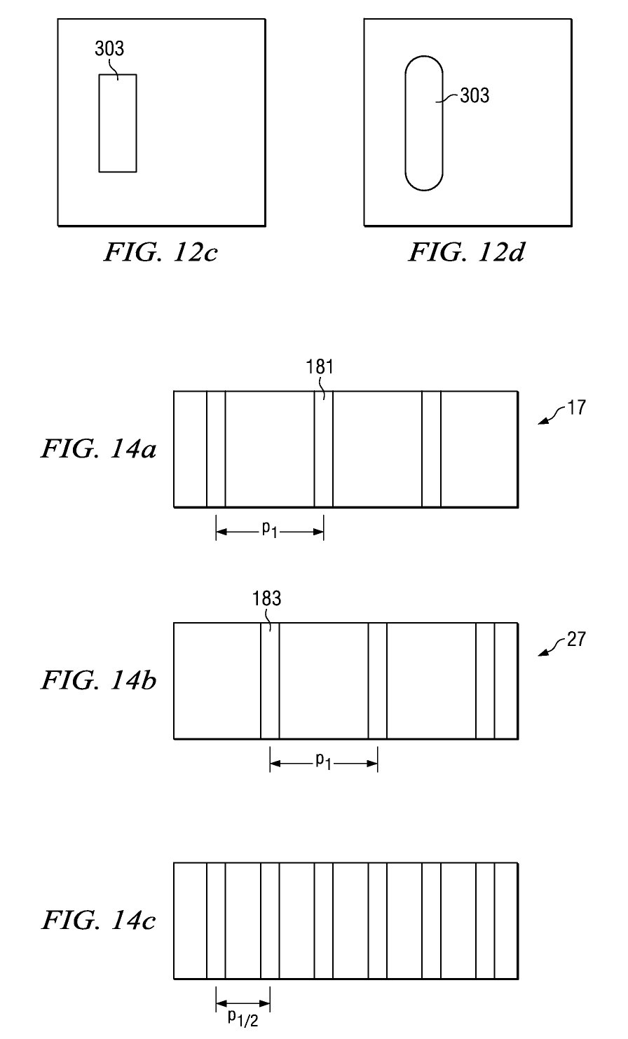

Despite the use of OPC techniques, current process technologies impose a narrow process window especially with continued shrinking of geometries. The lithography systems of e.g., FIGS. 1-4, in some embodiments, can be used to improve printing of features and reducing the requirements of OPC features. FIG. 12 illustrates an embodiment of using the lithography system, wherein the second mask 27 can be used to trim corners. Typically, corners of a feature get rounded due to interference effects. Rounded corners pose a number of problems, including limiting density, as they have to be over an isolation region. A number of OPC features such as hammerheads and serifs are drawn that partially overcome these limitations. In the embodiment described here, the second mask 27 of the lithography system (e.g., of FIG. 1) is adopted as an erase mask.

The first mask 17 shown in FIG. 12a comprises opaque regions 173 and transparent regions 174. The second mask shown in FIG. 12b, similarly, comprises opaque regions 273 and transparent regions 274. The superposition of the two optical beams 80 and 81 (e.g., of FIG. 1) creates a composite image as shown in FIG. 12c. Further, the transparent regions 274 of the second mask 27 overlaps with the opaque regions 173 of the first mask 17. Consequently, the features 303 are formed on the composite image. The features 303 have been trimmed in that their corners have been removed by the use of the second mask 27. In particular, the second mask 27 exposes the edges of features 303 not exposed by opaque regions 173 of the first mask 17. Hence, the composite image or exposure in FIG. 12c containing both the mask patterns does not contain the edges or round corners. For sake of clarity, FIG. 12d shows the image formed by the first mask 17, if the second mask 27 (optical beam through the second mask 27) is turned off. FIG. 12d illustrates the round corners not formed in the described embodiment in FIG. 12c. Although the current embodiment describes an erase mask for trimming corners, the embodiment includes all processes wherein the second mask 27 is used for erasing. For example, the first mask 17 could include printed assist features, while the second mask 27 could remove these features.

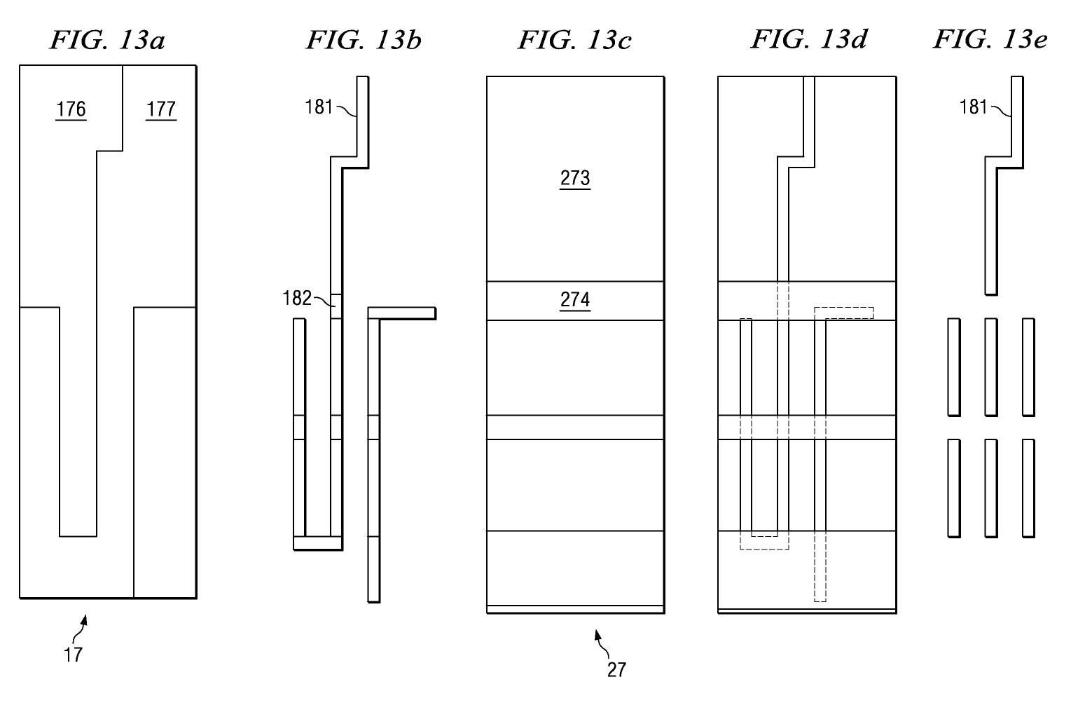

An embodiment of the invention relating to applications of chromeless phase lithography (CPL) is described in FIG. 13, which includes FIGS. 13a-13e, wherein FIGS. 13a and 13c describe the masks 17 and 27 and FIG. 13e illustrates the composite pattern formed by the superposition of the two separate optical beams 80 and 81 of e.g., FIG. 1. The embodiment described in FIG. 13 illustrates an example, wherein the first mask 17 comprises a phase shift mask and the second mask 27 comprises a binary mask.

Referring to FIG. 13a, the chromeless phase shift mask comprises two regions 176 and 177. The light passing through the regions 176 and 177 of the first mask 17 is phase shifted by a phase difference of 180 degrees (without significant difference in transmission). FIG. 13b illustrates the printed feature in the absence of the second mask. In FIG. 13b, the printed features comprise both the needed first features 181 and unwanted secondary features 182. FIG. 13c illustrates the design of a suitable trim mask containing the opaque regions 273 and transparent regions 274. The superposition of the printed image from the first mask 17 (illustrated in FIG. 13b) with the second mask 27 (illustrated in FIG. 13c) is illustrated in FIG. 13d. As illustrated, the transparent regions 274 coincide with the secondary features 182. Hence, as illustrated in FIG. 13e, the trim mask trims the secondary features 182 in the final image. Thus, the final printed features only contain the first features 181.

In various embodiments, the lithography system described in FIGS. 1-4 allows improving the effective k₁ of the lithography process. FIG. 14 illustrates such an embodiment describing pitch doubling. The first mask 17, shown in FIG. 14a, comprises a pitch p₁ that is printable by current technology. In other words, the distance p₁ is larger than or equal to the minimum printable resolution R of the lithography process. The second mask 27, shown in FIG. 14b, comprises the same feature but staggered by about half pitch or p₁/2. Hence, individually each mask comprises only pattern at a printable pitch p₁. The final exposed pattern is printed at half pitch or p₁/2 and is shown in FIG. 14c.

Embodiments of the invention will now be described using FIG. 15 for minimizing mask alignment errors in the embodiments of the lithography systems illustrated in FIGS. 1-4. A self-monitor feed-back loop ensures minimal mask alignment error between the two masks.

As described previously, for example, in FIG. 1, the first mask 17 is held by a first reticle stage 19 and the second mask 27 is held by a second reticle stage 29. Alignment systems are coupled to the first reticle stage 19 and the second reticle stage 29 to minimize mask alignment errors. For example, in various embodiments the alignment systems include interferometers, mirrors and mounts. The alignment systems are electrically coupled to a central control unit 680. The central control unit reads the locations of the reticle stages 19 and 29 using the alignment systems and realigns or readjusts the location of the reticle stages 19 and 29 to minimize mask alignment errors. This reticle stage alignment step may be performed either before exposure or between consecutive exposures.

In the embodiment described in FIG. 15a, the reticle stages 19 and 29 are compared to a reference location using an interferometer comprising a light emitter and detector. Mirrors 674 and 670 mounted on the projection lens system 50 are used as reference points, although in some embodiments, other parts of the lithography system can also be used as reference points. A mirror 678 is mounted on the first reticle stage 19 and locates the position of the first reticle stage 19. The optical path for a light signal emitted by the interferometer 650 comprises a first optical path to the reticle stage mirror 678 via the beam splitter 675 and mirror 676, and a second optical path via the beam splitter 675 and mirror 674. The path difference between the two optical paths is measured by a detector present inside the interferometer 650. This path difference gives a measure of any mismatch between the first reticle stage 19 and the projection lens system 50. The first reticle stage 19 may be moved till a satisfactory mismatch is achieved. Similarly, the second mask 27 housed by the second reticle stage 29 may be connected to an interferometer 651 using beam splitter 671 and mirrors 672 and 673. The relative mismatch between the first and second reticle stages 19 and 29 may be minimized or controlled by a central control unit 680.

Referring now to FIG. 15b, the first and second reticle stages 19 and 29 may also be directly monitored by a single interferometer 652. For example, a mirror 663 may be housed on the reticle stage 19 holding the first mask 17. Another mirror 660 is mounted on the second reticle stage 29. Beam splitter 662 and mirror 661 complete the optical paths. The interferometer 652 coupled with a central control unit 664 determines the relative difference between the first and second reticle stages 19 and 29. The stages can be adjusted based on the feedback from the central control unit 664.

Although the current embodiment used interferometers, various embodiments may use other techniques to detect and subsequently adjust the relative locations of the reticle stages.

The first mask 17 (e.g., of FIG. 1, 2, or 4) and second mask 27 (e.g., of FIG. 1, 2, or 4) may have additional features for testing the alignment of the masks and/or the optical characteristics of the optical beam. These patterns may appear on the wafer as a test pattern.

In various embodiments, overlay measurement patterns could be used for such a test measurement. FIG. 16 shows an exemplary test pattern that may be used to test the alignment of the masks 17 and 27 (e.g., of FIG. 1, 2, or 4). The test pattern comprises forming two embedded boxes 1001 and 1002 each imaged using a single mask on a wafer 701. For clarity, in FIG. 16, the two masks are shown as separate exposures, although in different embodiments, they may also be exposed together. The regions 1001 and 1002 share a common central region with a common centroid, and an unshared outer region on the periphery or edge of the pattern. The unshared region may be measured to determine misalignment due to the masks. For example, in a perfectly aligned system, the lengths L₁ and L₂ are about identical and the lengths L₂ and L₄ are identical. Any difference in the dimensions may arise from misalignment of the masks. Although only one pattern is shown, typically a number of such test patterns may be used in various regions of the wafer. Similarly, although only a square pattern is shown in the current embodiment, other shapes such as circles, triangles, rectangles, etc. may be used.

Embodiments of the present invention include methods of manufacturing semiconductor devices and devices manufactured using the lithography systems of FIGS. 1-4 described herein. FIG. 17a shows a cross-sectional view of a semiconductor device 70 that has a layer of photoresist 710 disposed thereon that has been patterned using a lithography system of an embodiment of the present invention. FIG. 17b shows the semiconductor device 70 of FIG. 17a after the layer of photoresist 710 has been used as a mask to pattern a material layer 720 of the semiconductor device 70.

Referring to FIG. 17a, the semiconductor device 70 includes a workpiece 730. The workpiece 730 may be held to a wafer support 60. The workpiece 730 may include a semiconductor substrate comprising silicon or other semiconductor materials covered by an insulating layer, for example. The workpiece 730 may also include other active components or circuits, not shown. The workpiece 730 may comprise silicon oxide over single-crystal silicon, for example. The workpiece 730 may include other conductive layers or other semiconductor elements, e.g., transistors, diodes, etc. Compound semiconductors, GaAs, InP, Si/Ge, or SiC, as examples, may be used in place of silicon. The workpiece 730 may comprise a silicon-on-insulator (SOI) substrate, for example.

An embodiment of the present invention describes a method using the lithography systems shown in FIGS. 1-4 to fabricate a semiconductor device 70. A sequence of process steps used in the formation of the semiconductor device 70 will now be described. A material layer 720 to be patterned is deposited over a workpiece 730. The material layer 720 may comprise a conductive, insulating, or semiconductive material, or multiple layers or combinations thereof, as examples. In some embodiments, the material layer 720 preferably comprises a semiconductive material such as silicon or polysilicon, for example, although other materials may also be used. In an embodiment where transistors are formed, the material layer 720 may comprise a gate dielectric material comprising an insulator and a gate material formed over the gate dielectric material, for example.

A layer of photosensitive material 710 is deposited over the material layer 720. The layer of photosensitive material 710 may comprise a photoresist, for example. The layer of photosensitive material 710 is patterned using the lithography masks 17 and 27 of e.g., FIG. 1 to form a latent pattern comprising a plurality of features 711 and 712 to be formed in the material layer 720. The layer of photosensitive material 710 is developed, as shown in FIG. 17a.

In some embodiments, the layer of photosensitive material 710 is used as a mask while the material layer 720 is etched using an etch process, forming a plurality of features 711 and 712 in the material layer 720, as shown in a cross-sectional view in FIG. 17b. The layer of photosensitive material 710 is then removed. The plurality of features in the material layer 720 may be contact holes, metal lines, via holes, gate lines, dummy gate lines, features for patterning isolation trenches, etc.

In other embodiments, the layer of photosensitive material 710 is used as a mask to affect an underlying material layer 720 of the semiconductor device 70, for example. Affecting the material layer 720 may comprise etching away uncovered portions of the material layer 720, implanting a substance such as a dopant or other materials into the uncovered portions of the material layer 720, or forming a second material layer over uncovered portions of the material layer 720, as examples (not shown), although alternatively, the material layer 720 may be affected in other ways. Further processing of the workpiece 730, using conventional semiconductor manufacturing techniques, forms the semiconductor device 70.

Features of semiconductor devices 70, manufactured using the novel methods described herein, may comprise transistor gates, conductive lines, vias, capacitor plates, and other features, as examples. Embodiments of the present invention may be used to pattern features of memory devices, logic circuitry, and/or power circuitry, as examples, although other types of ICs and devices may also be fabricated using the manufacturing techniques and processes described herein.

Embodiments of the present invention may be used in lithography processes that utilize positive or negative photoresists for patterning semiconductor devices 70, for example.

Embodiments of the invention also include methods of calculating the composite image on a photo resist layer or an image plane on the workpiece. In various embodiments, the method calculates the composite image by super positioning a plurality of image intensity distributions formed on a photo-resist layer, by a plurality of optical beams passing through corresponding masks. For example, in lithography systems discussed in FIG. 1, 2, or 4, a first image intensity distribution of a first optical beam 80 (e.g., of FIG. 1) passing through a first mask 17 (e.g., of FIG. 1) is super-positioned over a second image intensity distribution of a second optical beam 81 (e.g., of FIG. 1) passing through a second mask 27 (e.g., of FIG. 1). The resulting image intensity distribution is used in determining the exposed areas of the photo resist. In some embodiments, the electric field distributions may be super-positioned instead of the intensity distributions. In such embodiments, the image intensity distribution of the composite image may be calculated from the electric field distribution of the composite image.

Although embodiments of the present invention and their advantages have been described in detail, it should be understood that various changes, substitutions and alterations can be made herein without departing from the spirit and scope of the invention as defined by the appended claims. For example, it will be readily understood by those skilled in the art that many of the features, functions, processes, and materials described herein may be varied while remaining within the scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A lithography system comprising:
at least one illuminator disposed in the lithography system;
a common projection lens system disposed between the at least one illuminator and a wafer stage;
a first reticle stage for holding a first mask disposed between the at least one illuminator and the common projection lens system, wherein a first optical path passes the first reticle stage;
a second reticle stage for holding a second mask disposed between the at least one illuminator and the common projection lens system, wherein a second optical path passes the second reticle stage; and
at least one alignment system optically connected to the first reticle stage and the second reticle stage.

2. The lithography system of claim 1, further comprising optical switches disposed between the first and second reticle stages and the at least one illuminator, wherein the optical switches have independent control of each independent optical path.

3. The lithography system of claim 1, wherein the at least one illuminator comprises a first illuminator and a second illuminator, wherein the first illuminator is configured to generate the first optical path and the second illuminator is configured to generate the second optical path.

4. The lithography system of claim 1, further comprising a beam splitter disposed between the first and second reticle stages and the common projection lens system, wherein the beam splitter combines light beams passing the first reticle stage with the second reticle stage into a single light beam.

5. The lithography system of claim 1, wherein the at least one illuminator comprises a single illuminator to generate an optical path, the lithography system further comprising a first beam splitter to split the optical path into the first optical path and the second optical path.

6. The lithography system of claim 5, further comprising:
a first polarizer to linearly polarize a first optical beam passing the first reticle stage; and
a second polarizer to linearly polarize a second optical beam passing the second reticle stage.

7. The lithography system of claim 1, wherein the at least one alignment system comprises a first alignment system optically connected to the first reticle stage, and a second alignment system optically connected to the second reticle stage.

8. The lithography system of claim 7, wherein the first alignment system and the second alignment system are monitored by a single interferometer.

9. A method of forming a semiconductor device, the method comprising:
exposing a first region of a first mask comprising a plurality of first features, the plurality of first features optimally exposed by a first process window, the first process window comprising process parameters;
simultaneously exposing a second region of a second mask comprising a plurality of second features, the plurality of second features optimally exposed by a second process window, the second process window comprising process parameters; and
forming a pattern on a semiconductor body by a superposition of light intensities of light exposed by the first mask and the second mask.

10. The method of claim 9, wherein the first region of the first mask and the second region of the second mask expose different regions on the semiconductor body.

11. The method of claim 10, wherein the plurality of first features are spaced at a first pitch and the plurality of second features are spaced at a second pitch.

12. The method of claim 9, wherein the first region of the first mask and the second region of the second mask expose a same region on the semiconductor body.

13. The method of claim 12, wherein the plurality of second features erases a portion of the region on the semiconductor body formed by the plurality of first features.

14. The method of claim 13, wherein the plurality of second features trims corners of gate lines formed on the semiconductor body by the plurality of first features.

15. The method of claim 9, wherein the process parameters comprise parameters selected from the group consisting of polarization, exposure dose, exposure intensity, illumination angle and type of off-axis illumination.

16. A method of forming a semiconductor device on a wafer, the wafer comprising a plurality of regions, the method comprising:
(a) positioning a region of the wafer under a lithography system;
(b) exposing the region to a first optical beam transmitted through a first mask;
(c) turning off the first optical beam after exposing the region to the first optical beam;
(d) exposing the region to a second optical beam transmitted through a second mask; and
(e) turning off the second optical beam after exposing the region to the second optical beam; and
repeating steps (a) through (e) till the plurality of regions on the wafer are exposed by the first optical beam and the second optical beam.

17. The method of claim 16, wherein the first mask and the second mask expose a same area of the semiconductor device.

18. The method of claim 17, wherein a plurality of first features on the first mask and a plurality of second features on the second mask are identical, but staggered.

19. The method of claim 17, wherein a plurality of second features on the second mask erase a portion of the region on the semiconductor device exposed by a plurality of first features on the first mask.

20. The method of claim 16, further comprising:
aligning the first mask by a first alignment system; and
aligning the second mask by a second alignment system.
